(19) United States
(12) Patent Application Publication
(10) Pub. No.: US 2025/0169523 A1
(43) Pub. Date: May 29, 2025

(54) LUTEIN/ZEAXANTHIN FORMULATIONS

(71) Applicant: DSM IP ASSETS B.V., Heerlen (NL)

(72) Inventors: Francesco ALOISE, Kaiseraugst (CH); Christian SCHAEFER, Kaiseraugst (CH); Roland SCHEX, Kaiseraugst (CH); Bernd SCHLEGEL, Kaiseraugst (CH); Thomas ZWICK, Kaiseraugst (CH)

(21) Appl. No.: 18/840,221

(22) PCT Filed: Feb. 21, 2023
(86) PCT No.: PCT/EP2023/054255

§ 371 Date: Aug. 21, 2024

(30) Foreign Application Priority Data
Feb. 25, 2022 (EP) 22158901.3

(51) Int. Cl. A23L 5/44; A23L 29/10

(52) U.S. Cl. CPC A23L 5/44; A23L 29/10

(57) ABSTRACT

The present invention relates to a new formulation comprising a mixture of lutein and zeaxanthin in a specific ratio, polysorbate and water. The formulation can be used in a variety of products (such food, feed, dietary supplements, pharmaceuticals, or other products).

The present invention relates to a new formulation comprising a mixture of lutein and zeaxanthin in a specific ratio, polysorbate and water. The formulation can be used in edible products (such as food, feed, dietary supplements, pharmaceuticals, or other products).

The formulations according to the present invention are used in coloring edible products. These products can be in any commonly form. This means it can be liquid, gel-like or solid.

Coloration of edible products is an important field of application. Therefore, there is always a need to provide formulations, which are suitable to color such products.

The present invention comprises a mixture of lutein, which is the following compound

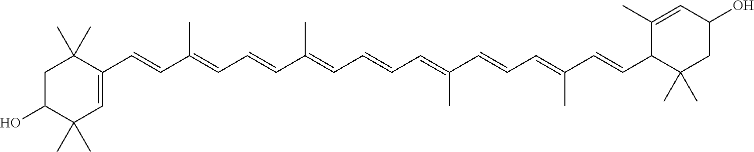 [SMILES: CC1=CC(O)CC(C)(C)C1/C=C/C(C)=C/C=C/C(C)=C/C=C/C=C(C)/C=C/C=C(C)/C=C/C1=CC(C)(C)C(O)CC1(C)C]

and zeaxanthin, which is the following compound

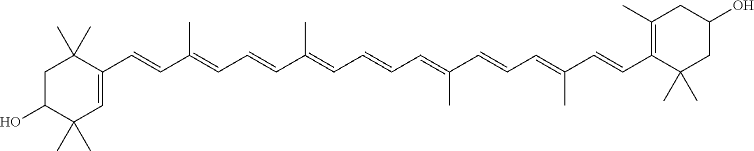 [SMILES: CC1=C(/C=C/C(C)=C/C=C/C(C)=C/C=C/C=C(C)/C=C/C=C(C)/C=C/C2=CC(C)(C)C(O)CC2(C)C)C(C)(C)CC(O)C1]

in a specific ratio.

Lutein is a carotenoid having anti-inflammatory properties. Lutein has several beneficial effects, especially on eye health. In particular, lutein is known to improve or even prevent age-related macular disease which is the leading cause of blindness and vision impairment.

Zeaxanthin is a carotenoid found in the cells of (human) eyes. Zeaxanthin has potent antioxidant properties and, as well as lutein, zeaxanthin has beneficial effects on eye health (such as reducing the risk of age-related macular degeneration, glaucoma, and cataracts).

Lutein and zeaxanthin are yellow-orange plant carotenoid pigments known as xanthophylls that can be found in nature (for example in green leafy vegetables, especially kale and spinach; egg yolk is another rich source of them).

It is also possible to produce these carotenoids synthetically (either using a chemical or a biochemical way).

The present invention relates to a formulation (F) comprising
(i) 1 to 50 wt-%, based on the total weight of the formulation, of a mixture of lutein and zeaxanthin, and
(ii) 3 to 15 wt-%, based on the total weight of the formulation, of at least one polysorbate, and
(iii) 20 to 70 wt-%, based on the total weight of the formulation, of water, and
(iv) 0-45 wt-%, based on the total weight of the formulation, of at least one auxiliary agent,
wherein the ratio of lutein to zeaxanthin in the mixture is 10:1 to 1:1 (based on the total weight of the lutein and zeaxanthin mixture).

The percentages in all formulation according to the present invention always add up to 100.

The formulation according to the present invention does not comprise any further carotenoid selected from the group consisting of bixin, β-carotene, α-carotene, apocarotenals, canthaxanthin, saffron, crocin, capsanthin, capsorubin, astaxanthin, rubixanthin, violaxanthin, rhodoxanthin and lycopene.

This means that none to these carotenoids (bixin, β-carotene, α-carotene, apocarotenals, canthaxanthin, saffron, crocin, capsanthin, capsorubin, astaxanthin, rubixanthin, violaxanthin, rhodoxanthin and lycopene) are added to the formulation intentionally. It might be that some of these carotenoids are present in the formulation in traces (depending how the lutein and or the zeaxanthin are obtained.)

The overall content of further carotenoids selected from the group consisting of bixin, β-carotene, α-carotene, apocarotenals, canthaxanthin, saffron, crocin, capsanthin, capsorubin, astaxanthin, rubixanthin, violaxanthin, rhodoxanthin and lycopene is low. Usually, the overall content of the further carotenoids selected from the group consisting of bixin, β-carotene, α-carotene, apocarotenals, canthaxanthin, saffron, crocin, capsanthin, capsorubin, astaxanthin, rubixanthin, violaxanthin, rhodoxanthin and lycopene is below 3 wt-%, based on the total weight of the formulation (Preferably below 2 wt-%, based on the total weight of the formulation, more preferably below 1 wt-%, based on the total weight of the formulation).

The present invention relates to a formulation (F′) comprising
(i) 1 to 50 wt-%, based on the total weight of the formulation, of a mixture of lutein and zeaxanthin, and
(ii) 3 to 15 wt-%, based on the total weight of the formulation, of at least one polysorbate, and
(iii) 20 to 70 wt-%, based on the total weight of the formulation, of water, and
(iv) 0-45 wt-%, based on the total weight of the formulation, of at least one auxiliary agent,
wherein the ratio of lutein to zeaxanthin in the mixture is 10:1 to 1:1 (based on the total weight of the lutein and zeaxanthin mixture) and wherein the formulation does not comprise any further carotenoid selected from the group consisting of bixin, β-carotene, α-carotene, apocarotenals, canthaxanthin, saffron, crocin, capsanthin, capsorubin, astaxanthin, rubixanthin, violaxanthin, rhodoxanthin and lycopene.

The present invention relates to a formulation (F″) consisting (essentially) of
(i) 1 to 50 wt-%, based on the total weight of the formulation, of a mixture of lutein and zeaxanthin, and
(ii) 3 to 15 wt-%, based on the total weight of the formulation, of at least one polysorbate, and
(iii) 20 to 70 wt-%, based on the total weight of the formulation, of water, and
(iv) 0-45 wt-%, based on the total weight of the formulation, of at least one auxiliary agent,
wherein the ratio of lutein to zeaxanthin in the mixture is 10:1 to 1:1 (based on the total weight of the lutein and zeaxanthin mixture).

The present invention relates to a formulation (F″) consisting (essentially) of
(i) 1 to 50 wt-%, based on the total weight of the formulation, of a mixture of lutein and zeaxanthin, and
(ii) 3 to 15 wt-%, based on the total weight of the formulation, of at least one polysorbate, and
(iii) 35 to 70 wt-%, based on the total weight of the formulation, of water,
wherein the ratio of lutein to zeaxanthin in the mixture is 10:1 to 1:1 (based on the total weight of the lutein and zeaxanthin mixture).

The formulation according to the present invention comprises 1 to 50 weight-% (wt-%), based on the total weight of the formulation, of the lutein/zeaxanthin mixture. Preferably, 1.5 to 40 wt-%, based on the total weight of the formulation, of the lutein/zeaxanthin mixture.

Therefore, the present invention relates to a formulation (F1), which is formulation (F), (F′), (F″) or (F′″) comprising 1.5 to 40 wt-%, based on the total weight of the formulation, of the lutein/zeaxanthin mixture.

The ratio of lutein to zeaxanthin in the mixture is between 10:1 to 1:1 (based on the total weight of the lutein and zeaxanthin mixture).

The ratio of lutein to zeaxanthin in the mixture is preferably between 8:1 to 3:1 (based on the total weight of the lutein and zeaxanthin mixture).

The ratio of lutein to zeaxanthin in the mixture is more preferably between 7:1 to 3:1 (based on the total weight of the lutein and zeaxanthin mixture).

The ratio of lutein to zeaxanthin in the mixture is even more preferably between 6:1 to 3:1 (based on the total weight of the lutein and zeaxanthin mixture).

More preferably, the ratio of lutein to zeaxanthin in the mixture is 5:1 to 4:1 (based on the total weight of the lutein and zeaxanthin mixture).

Therefore, the present invention relates to a formulation (F2), which is formulation (F), (F′), (F″), (F′″) or (F1), wherein the ratio of lutein to zeaxanthin in the mixture is 8:1 to 3:1 (based on the total weight of the lutein and zeaxanthin mixture).

Therefore, the present invention relates to a formulation (F2′), which is formulation (F), (F′), (F″), (F′″) or (F1), wherein the ratio of lutein to zeaxanthin in the mixture is 7:1 to 3:1 (based on the total weight of the lutein and zeaxanthin mixture).

Therefore, the present invention relates to a formulation (F2″), which is formulation (F), (F′), (F″), (F′″) or (F1), wherein the ratio of lutein to zeaxanthin in the mixture is 6:1 to 3:1 (based on the total weight of the lutein and zeaxanthin mixture).

Therefore, the present invention relates to a formulation (F2′″), which is formulation (F), (F′), (F″), (F′″) or (F1), wherein the ratio of lutein to zeaxanthin in the mixture is 5:1 to 4:1 (based on the total weight of the lutein and zeaxanthin mixture).

The particle sizes Dᵥ(90) of the lutein and the zeaxanthin in the mixture are less than 5 μm, preferably less than 3 μm (usually a particles size range (Dᵥ(90)) is 0.5 μm-5 μm, a preferred range is 1 μm to 3 μm).

The particle size distribution was determined by using a laser diffraction equipment (Malvern Mastersizer 3000) according to the Fraunhofer scattering model in a diluted aqueous suspension.

Therefore, the present invention relates to a formulation (F3), which is formulation (F), (F′), (F″), (F′″), (F1), (F2), (F2′), (F2″) or (F2″), wherein the particle sizes Dᵥ(90) of the lutein and the zeaxanthin in the mixture are less than 5 μm.

Therefore, the present invention relates to a formulation (F3′), which is formulation (F), (F′), (F″), (F″), (F1), (F2), (F2′), (F2″) or (F2″), wherein the particle sizes Dᵥ(90) of the lutein and the zeaxanthin in the mixture are less than 3 μm.

Therefore, the present invention relates to a formulation (F3″), which is formulation (F), (F′), (F″), (F″), (F1), (F2), (F2′), (F2″) or (F2″), wherein the particle sizes Dᵥ(90) of the lutein and the zeaxanthin in the mixture are 0.5 μm-5 μm (preferably 1 μm to 3 μm).

The formulation according to the present invention comprises at least one polysorbate.

Polysorbates are compounds of the following formula (I)

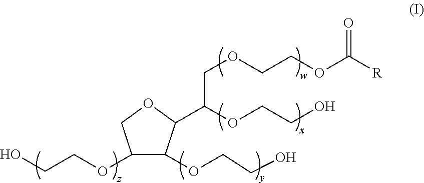

wherein
w, x, y and z are independently from each other integers which sum up to 20, and R is a linear or branched C₁₀-C₁₈-alkyl moiety or a linear or branched C₁₀-C₁₈-alkylene moiety.

Preferred polysorbates are compounds of formula (I),
wherein w, x, y and z are independently from each other integers which sum up to 20, and
R is a linear C₁₁-alkyl, a linear C₁₇-alkyl moiety or a linear C₁₇-alkylene moiety (preferably of formula —(CH₂)−CH═CH−(CH₂)₇CH₃).

Especially preferred are the following polysorbates (as such or as mixtures) polysorbate 20, polysorbate 60 and polysorbate 80.

Such suitable polysorbates are available commercially from a variety of suppliers (such as Oxiteno, Croda, Seppic) under tradenames (such as Montanox, Alkest TW, Tween).

Therefore, the present invention relates to a formulation (F4), which is formulation (F), (F′), (F″), (F″), (F1), (F2), (F2′), (F2″), (F2″), (F3), (F3′) or (F3″), wherein the at least one polysorbate is a compound of formula (I)

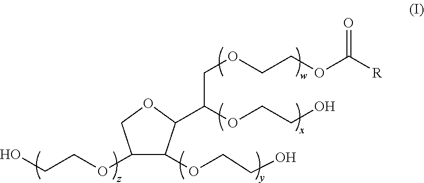

wherein
w, x, y and z are independently from each other integers which sum up to 20, and R is a linear C₁₁-alkyl, a linear C₁₇-alkyl moiety or a linear C₁₇-alkylene moiety (preferably of formula —(CH₂)—CH═CH—(CH₂)₇CH₃).

Therefore, the present invention relates to a formulation (F4′), which is formulation (F), (F′), (F″), (F″), (F1), (F2), (F2′), (F2″), (F2″), (F3), (F3′) or (F3″), wherein the at least one polysorbate is chosen from the group consisting of polysorbate 20, polysorbate 60 and polysorbate 80.

The formulation according to the present invention comprises 3 to 15 wt-%, based on the total weight of the formulation, of at least one polysorbate (preferably 3 to 12 wt-%, more preferably 4 to 10 wt-%, based on the total weight of the formulation, of at least one polysorbate.

Therefore, the present invention relates to a formulation (F5), which is formulation (F), (F′), (F″), (F″), (F1), (F2), (F2′), (F2″), (F2″), (F3), (F3′), (F3″), (F4) or (F4′) comprising 3 to 12 wt-%, based on the total weight of the formulation, of at least one polysorbate.

Therefore, the present invention relates to a formulation (F5′), which is formulation (F), (F′), (F″), (F″), (F1), (F2), (F2′), (F2″), (F2″), (F3), (F3′), (F3″), (F4) or (F4′) comprising 4 to 10 wt-%, based on the total weight of the formulation, of at least one polysorbate.

Furthermore, the formulation according to the present invention comprises 20 to 70 wt-%, based on the total weight of the formulation, of water (preferably 25 to 65 wt-%, more preferably 30 to 65 wt-%, based on the total weight of the formulation).

Therefore, the present invention relates to a formulation (F6), which is formulation (F), (F′), (F″), (F1), (F2), (F2′), (F2″), (F2″), (F3), (F3′), (F3″), (F4), (F4′), (F5) or (F5′) comprising 25 to 65 wt-%, based on the total weight of the total weight of the formulation, of water.

Therefore, the present invention relates to a formulation (F6′), which is formulation (F), (F′), (F″), (F1), (F1′), (F2), (F2′), (F2″), (F2″), (F3), (F3′), (F3″), (F4), (F4′), (F5) or (F5′) comprising 30 to 60 wt-%, based on the total weight of the total weight of the formulation, of water.

The formulation according to the present invention can optionally comprise at least one auxiliary agent.

Such auxiliary agent can be for example antioxidants, humectants (such as glycerol), plasticizers, sweeteners, buffering agents, and acidifiers.

But it is preferred not to add any antioxidant to the formulation

Especially preferred is the addition of glycerol.

Such auxiliary agent can be used in an amount of up to 45 wt-%, based on the total weight of the formulation.

Therefore, the present invention relates to a formulation (F7), which is formulation (F), (F′), (F″), (F1), (F2), (F2′), (F2″), (F2″), (F3), (F3′), (F3″), (F4), (F4′), (F5), (F5′), (F6) or (F6′) comprising at least one auxiliary agent selected from the group consisting of antioxidants, humectants (such as glycerol), plasticizers, sweeteners, buffering agents, and acidifiers.

Therefore, the present invention relates to a formulation (F7′), which is formulation (F), (F′), (F″), (F1), (F2), (F2′), (F2″), (F2″), (F3), (F3′), (F3″), (F4), (F4′), (F5), (F5′), (F6) or (F6′) comprising 5 to 45 wt-%, based on the total weight of the formulation, of at least one auxiliary agent.

Therefore, the present invention relates to a formulation (F8), which is formulation (F), (F′), (F″), (F1), (F2), (F2′), (F2″), (F2″), (F3), (F3′), (F3″), (F4), (F4′), (F5), (F5′), (F6) or (F6′), which is free from any antioxidant.

Therefore, the present invention relates to a formulation (F9), which is formulation (F), (F′), (F″), (F1), (F2), (F2′), (F2″), (F2″), (F3), (F3′), (F3″), (F4), (F4′), (F5), (F5′), (F6), (F6′) or (F8), wherein the auxiliary agent is glycerol.

Therefore, the present invention relates to a formulation (F9′), which is formulation (F9) comprising 10 to 45 wt-%, based on the total weight of the formulation, of glycerol.

The formulations according to the present invention can be used in a variety of fields of application, such as food, feed, dietary supplements, pharmaceuticals, and personal care products. These products can be in any form (such as solid, liquid or gel-like).

Preferably the formulations according to the present invention are used for incorporating into any edible products (such as i.e. food, feed, dietary supplements). The edible products can be in any form (such as solid, liquid or gel-like).

Most preferred are food and dietary supplements.

Especially preferred are food products such as beverages (such as carbonated, non-carbonated, pasteurised non-pasteurised, juice drinks, coffee drinks, etc)

Very preferred are beverages such sport drinks, energy drinks (with or without coffein), tea drinks, coffee drinks, etc.

Therefore, the present invention also related to the use of at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′) in food, feed, dietary supplements, pharmaceuticals, and personal care products.

Therefore, the present invention also related to the use of at least one formulation (F), (F′), (F″), (F′″), (F1), (F2), (F2′), (F2″), (F2″), (F3), (F3′), (F3″), (F4), (F4′), (F5), (F5′), (F6), (F6′), (F7), (F7′), (F8), (F9) or (F9′) in edible products.

Therefore, the present invention also related to the use of at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′) in food and dietary supplements.

Therefore, the present invention also related to the use of at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′) in beverages (such as carbonated, non-carbonated, pasteurised non-pasteurised, juice drinks, coffee drinks etc)

Therefore, the present invention also related to the use of at least one formulation (F), (F′), (F″), (F″), (F1), (F2), (F2′), (F2″), (F2′″), (F3), (F3′), (F3″), (F4), (F4′), (F5), (F5′), (F6), (F6′), (F7), (F7′), (F8), (F9) or (F9′) in sport drinks, energy drinks (with or without coffein), tea drinks and coffee drinks.

Furthermore, the present invention also relates to food, feed, dietary supplements, pharmaceuticals and personal care products comprising at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′).

Furthermore, the present invention also relates to edible products comprising at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′).

Furthermore, the present invention also relates to food and dietary supplements comprising at least one (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′).

Furthermore, the present invention also relates to beverages (such as carbonated, non-carbonated, pasteurised non-pasteurised, juice drinks, coffee drinks etc) comprising at least one formulation (F), (F′), (F″), (F″), (F1), (F2), (F2′), (F2″), (F2′″), (F3), (F3′), (F3″), (F4), (F4′), (F5), (F5′), (F6), (F6′), (F7), (F7′), (F8), (F9) or (F9′).

Furthermore, the present invention also relates to sport drinks, energy drinks (with or without coffein), tea drinks and coffee drinks comprising at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′).

Therefore, the present invention also related to the use of at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′) in beverages (such as carbonated, non-carbonated, pasteurised non-pasteurised, juice drinks, coffee drinks etc)

Therefore, the present invention also related to the use of at least one formulation (F), (F′), (F″), (F″), (F1), (F2), (F2′), (F2″), (F2″), (F3), (F3′), (F3″), (F4), (F4′), (F5), (F5′), (F6), (F6′), (F7), (F7′), (F8), (F9) or (F9′) in sport drinks, energy drinks (with or without coffein), tea drinks and coffee drinks.

The amount of these formulation used in the food, feed, dietary supplements, pharmaceuticals and personal care products depends on the product, which is to be produced.

The following examples illustrate the present invention.

All the parts and percentages in the Examples are related to the weight (when not otherwise stated) and the temperature is given in ° C. (when not otherwise stated).

### EXAMPLES

### General Remarks:

High-performance liquid chromatography-diode array detection (HPLC-DAD) analyses were used to quantitate the concentrations of lutein and zeaxanthin in the starting materials FloraGLO Lutein (from Kemin Foods L.C) and ZeaONE Cake Base (from Kemin Foods L.C), respectively. The aforementioned starting materials were mixed accordingly to yield a ratio of 5:1 to 4:1 of lutein to zeaxanthin.

### Example 1

434.3 g deionized water and 62.2 g Polysorbate 80 were mixed in a glass bottle for 30 min at 55° C. under continuous stirring. The matrix was cooled to room temperature and the pH was adjusted to pH 3.0 by the addition of phosphoric acid (10%) in adequate amounts.

200.1 g crystalline FloraGLO Lutein (from Kemin Foods L.C) and 37.8 g ZeaONE Cake Base (from Kemin Foods L.C) were weighed in a beaker, the matrix was added, and the raw suspension was mixed using a rotor-stator device (Ultra Turrax T50) at 6000 rpm.

The mixed suspension was transferred into lab-scale agitated ball mill (Dispermat SL-12-C₁, bead diameter: 0.4 mm; bead material: Yttrium stabilized zirconium oxide) and continuously comminuted for ca. up to 120 min. The particle size distribution was monitored throughout the process using a laser diffraction equipment (Malvern Mastersizer 3000) according to the Fraunhofer scattering model. The obtained particles size in a diluted aqueous suspension was Dᵥ(90)<5 μm.

The milled suspension was mixed with adequate amounts of glycerol to yield suspension compositions as described in Example 2 and Example 3 (see Table 1).

### Example 4

434.3 g deionized water and 62.2 g Polysorbate 20 were mixed in a glass bottle for 30 min at 55° C. under continuous stirring. The matrix was cooled to room temperature and the pH was adjusted to pH 3.0 by the addition of phosphoric acid (10%) in adequate amounts.

200.1 g crystalline FloraGLO Lutein (from Kemin Foods L.C) and 37.8 g ZeaONE Cake Base (from Kemin Foods L.C) were weighed in a beaker, the matrix was added, and the raw suspension was mixed using a rotor-stator device (Ultra Turrax T50) at 6000 rpm.

The mixed suspension was transferred into lab-scale agitated ball mill (Dispermat SL-12-C1, bead diameter: 0.4 mm; bead material: Yttrium stabilized zirconium oxide) and continuously comminuted for ca. up to 120 min. The particle size distribution was monitored throughout the process using a laser diffraction equipment (Malvern Mastersizer 3000) according to the Fraunhofer scattering model. The obtained particles size in a diluted aqueous suspension was Dᵥ(90)<5 μm.

The milled suspension of Example 2a was mixed with adequate amounts of glycerol to yield suspension compositions as described in Example 5 and Example 6 (see Table 1).

### Example 7

341.3 g deionized water, 49.2 g Polysorbate 80, and 145.0 g glycerol were mixed in a glass bottle for 30 min at 55° C. under continuous stirring. The matrix was cooled to room temperature and the pH was adjusted to pH 3.0 by the addition of phosphoric acid (10%) in adequate amounts.

158.6 g crystalline FloraGLO Lutein (from Kemin Foods L.C) and 29.9 g ZeaONE Cake Base (from Kemin Foods L.C) were weighed in a beaker, the matrix was added, and the raw suspension was mixed using a rotor-stator device (Ultra Turrax T50) at 6000 rpm.

The mixed suspension was transferred into lab-scale agitated ball mill (Dispermat SL-12-C₁, bead diameter: 0.4 mm; bead material: Yttrium stabilized zirconium oxide) and continuously comminuted for ca. up to 120 min. The particle size distribution was monitored throughout the process using a laser diffraction equipment (Malvern Mastersizer 3000) according to the Fraunhofer scattering model. The obtained particles size in a diluted aqueous suspension was Dᵥ(90)<5 μm.

Example 8 was manufactured in the same way as Example 7, using Polysorbate 20 instead of Polysorbate 80 (see Table 1).

TABLE 1
Compositions of wet-milled suspensions.

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Deionized | 59.1 | 47.5 | 35.9 | 59.1 | 47.5 | 35.9 | 47.1 | 47.1 |
| Water | | | | | | | | |
| Glycerol | — | 19.6 | 39.2 | — | 19.6 | 39.2 | 20.0 | 20.0 |
| Polysorbate | — | — | — | 8.5 | 6.8 | 5.2 | — | 6.8 |
| 20 | | | | | | | | |
| Polysorbate | 8.5 | 6.8 | 5.2 | — | — | — | 6.8 | — |
| 80 | | | | | | | | |
| Lutein/ | 25.5 | 20.5 | 15.5 | 25.5 | 20.5 | 15.5 | 20.5 | 20.5 |
| Zeaxanthin | | | | | | | | |
| (5:1 to 4:1) | | | | | | | | |
| Tagetes | 6.9 | 5.5 | 4.2 | 6.9 | 5.5 | 4.2 | 5.5 | 5.5 |
| Oleoresin | | | | | | | | |
| Residuals | | | | | | | | |

1. A formulation comprising
(i) 1.5 to 40 wt-%, based on the total weight of the formulation, of a mixture of lutein and zeaxanthin, and
(ii) 3 to 15 wt-%, based on the total weight of the formulation, of at least one polysorbate, and
(iii) 20 to 70 wt-%, based on the total weight of the formulation, of water, and
(iv) 0-45 wt-%, based on the total weight of the formulation, of at least one auxiliary agent,
wherein the ratio of lutein to zeaxanthin in the mixture is 10:1 to 1:1 (based on the total weight of the lutein and zeaxanthin mixture).

2. The formulation according to claim 1, wherein the formulation does not comprise any further carotenoid selected from the group consisting of bixin, b-carotene, α-carotene, apocarotenals, canthaxanthin, saffron, crocin, capsanthin, capsorubin, astaxanthin, rubixanthin, violaxanthin, rhodoxanthin and lycopene

3. The formulation according to claim 1, wherein the ratio of lutein to zeaxanthin in the mixture is 8:1 to 3:1 (based on the total weight of the lutein and zeaxanthin mixture).

4. The formulation according to claim 1, wherein the particle sizes Dᵥ(90) of the lutein and the zeaxanthin in the mixture are less than 5 mm.

5. The formulation according to claim 1, wherein the at least one polysorbate is a compound of formula (I) 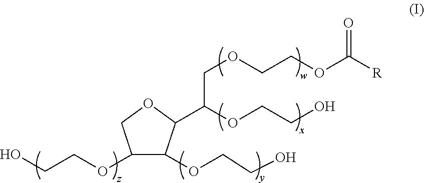
wherein
w, x, y and z are independently from each other integers which sum up to 20, and
R is a linear C₁₁-alkyl, a linear C₁₇-alkyl moiety or a linear C₁₇-alkylene moiety (preferably of formula —(CH₂)—CH═CH—(CH₂)₇CH₃).

6. The formulation according to claim 1, wherein the at least one polysorbate is chosen from the group consisting of polysorbate 20, polysorbate 60 and polysorbate 80.

7. The formulation according to claim 1 comprising 25 to 65 wt-%, based on the total weight of the total weight of the formulation, of water.

8. The formulation according to claim 1 comprising at least one auxiliary agent selected from the group consisting of antioxidants, humectants (such as glycerol), plasticizers, sweeteners, buffering agents, and acidifiers.

9. The formulation according to claim 1, which is free from any antioxidant.

10. The formulation according to claim 1, wherein the auxiliary agent is glycerol.

11. Use of at least one formulation according to claim 1 in food, feed, dietary supplements, pharmaceuticals and personal care products

12. Use of at least one formulation according to claim 1 in edible products.

13. Food, feed, dietary supplements, pharmaceuticals and personal care products comprising at least one formulation according to claim 1.

14. Edible products comprising at least one formulation according to claim 1.
